(19) United States
(12) Patent Application Publication
(10) Pub. No.: US 2018/0211249 A1
(43) Pub. Date: Jul. 26, 2018

(54) ENABLING AUTHENTICATION SHIFTING BASED ON MOBILE WALLET CHARACTERISTICS

(71) Applicant: Bank of America Corporation, Charlotte, NC (US)

(72) Inventors: Scott Anderson Sims, Tega Cay, SC (US); Tony England, Tega Cay, SC (US); Shawn Parris Bench, Wilmington, DE (US); Andrew Dongho Kim, Glendale, AZ (US); Jeffrey Thomas Zusi, Charlotte, NC (US)

(21) Appl. No.: 15/415,706

(22) Filed: Jan. 25, 2017

(51) Int. Cl. G06Q 20/36; G06Q 20/34; H04L 29/06

(52) U.S. Cl. CPC G06Q 20/3674; H04L 63/083; G06Q 20/3672; G06Q 20/352

(57) ABSTRACT

Embodiments are directed to enabling authentication shifting based on mobile wallet characteristics such as presence and/or content of a payment credential or pre-generated token. Embodiments receive a request for access to a function or feature by a user of the mobile device; receive first user authentication credentials from the user; access a mobile wallet storing at least one payment credential associated with an owner of the mobile device, the at least one payment credential comprising owner identity information; compare the first user authentication credentials with the owner identity information; confirm the first user authentication credentials match the owner identity information; and enable access to the requested function or feature. Embodiments also determine that additional user authentication is required for access to the requested function or feature; receive and validate second user authentication credentials; and enable access to one or more features or functions of a mobile application.

### BACKGROUND

In the new technological age, the security of personal information, or the lack thereof, has become an issue that concerns many people. As a result, several business industries, such as financial institutions, have taken precautionary measures to ensure the safety and protection of their customers' information. Users leverage digital wallets to make purchases, but the setup of digital wallets may introduce opportunities for sensitive data exposure.

### BRIEF SUMMARY

Embodiments of the invention are directed to a mobile device for A mobile device for providing step-up authentication, the mobile device comprising a memory; a processor; and a module stored in the memory, executable by the processor, and configured to receive a request for access to a function or feature by a user of the mobile device; receive first user authentication credentials from the user; access a mobile wallet storing at least one payment credential associated with an owner of the mobile device, the at least one payment credential comprising owner identity information; compare the first user authentication credentials with the owner identity information; confirm the first user authentication credentials match the owner identity information; and enable access to the requested function or feature.

In some embodiments, the module is further configured to determine that additional user authentication is required for access to the requested function or feature; receive second user authentication credentials; validate the second user authentication credentials; and, in response to validation, enable access to one or more features or functions of a mobile application.

In some embodiments, the mobile device further comprises a contactless reader; where the module is executable by the processor and further configured to receive, from the contactless reader, contactless credential information comprising owner identification, credential number, expiration date and cryptogram; load the contactless credential information into a digital wallet stored in the memory; and enable use of a payment token corresponding to the contactless credential information in a digital wallet transaction. In some such embodiments, the module is further configured to cause the mobile application to access user identity information associated with the mobile device; compare the accessed user identity information with the contactless credential owner identification; and, in response to successful comparison, load the contactless credential information into the digital wallet and enable use of a payment token corresponding to the contactless credential information. In other such embodiments, the module is further configured to conduct an EMV transaction using the digital wallet and the payment credential; based on successful completion of the EMV transaction using the digital wallet and the payment credential and successful authentication validation, enable access to the requested function or feature. In yet other such embodiments, the contactless reader comprises an NFC reader and the contactless credential comprises a contactless payment card including an NFC chip.

In some embodiments, the module is further configured to generate a digital wallet token representing a hard payment credential in conjunction with a digital wallet set-up process; and where the stored payment credential is the digital wallet token.

According to embodiments of the invention, a method for providing step-up authentication includes receive a request for access to a function or feature by a user of the mobile device; receiving first user authentication credentials from the user; accessing a mobile wallet storing at least one payment credential associated with an owner of the mobile device, the at least one payment credential comprising owner identity information; comparing the first user authentication credentials with the owner identity information; confirming the first user authentication credentials match the owner identity information; and enabling access to the requested function or feature.

In some embodiments, determining that additional user authentication is required for access to the requested function or feature; receiving second user authentication credentials; validating the second user authentication credentials; and, in response to validation, enabling access to one or more features or functions of a mobile application.

In other embodiments, the method includes receiving, from a contactless reader, contactless credential information comprising owner identification, credential number, expiration date and cryptogram; loading the contactless credential information into a digital wallet stored in the memory; and enabling use of a payment token corresponding to the contactless credential information in a digital wallet transaction. In some such embodiments, the method includes causing the mobile application to access user identity information associated with the mobile device; comparing the accessed user identity information with the contactless credential owner identification; and, in response to successful comparison, loading the contactless credential information into the digital wallet and enable use of a payment token corresponding to the contactless credential information. In other such embodiments, the method includes conducting an EMV transaction using the digital wallet and the payment credential; and based on successful completion of the EMV transaction using the digital wallet and the payment credential and successful authentication validation, enabling access to the requested function or feature. In yet other such embodiments, the contactless reader comprises an NFC reader and the contactless credential comprises a contactless payment card including an NFC chip.

In some embodiments, the method includes generating a digital wallet token representing a hard payment credential in conjunction with a digital wallet set-up process; and where the stored payment credential is the digital wallet token.

According to other embodiments of the invention, a computer program product provides step-up authentication and includes a non-transitory computer-readable medium comprising code causing a mobile device to receive a request for access to a function or feature by a user of the mobile device; receive first user authentication credentials from the user; access a mobile wallet storing at least one payment credential associated with an owner of the mobile device, the at least one payment credential comprising owner identity information; compare the first user authentication credentials with the owner identity information; confirm the first user authentication credentials match the owner identity information; and enable access to the requested function or feature.

In some embodiments, the code further causes the mobile device to determine that additional user authentication is required for access to the requested function or feature; receive second user authentication credentials; validate the second user authentication credentials; and, in response to validation, enable access to one or more features or functions of a mobile application.

In some embodiments, the code further causes the mobile device to receive, from a contactless reader, contactless credential information comprising owner identification, credential number, expiration date and cryptogram; load the contactless credential information into a digital wallet stored in the memory; and enable use of a payment token corresponding to the contactless credential information in a digital wallet transaction. In some such embodiments, the code further causes the mobile device to cause the mobile application to access user identity information associated with the mobile device; compare the accessed user identity information with the contactless credential owner identification; and, in response to successful comparison, load the contactless credential information into the digital wallet and enable use of a payment token corresponding to the contactless credential information. In other such embodiments, the code further causes the mobile device to conduct an EMV transaction using the digital wallet and the payment credential; based on successful completion of the EMV transaction using the digital wallet and the payment credential and successful authentication validation, enable access to the requested function or feature.

In some embodiments, the code further causes the mobile device to generate a digital wallet token representing a hard payment credential in conjunction with a digital wallet set-up process, where the stored payment credential is the digital wallet token.

### BRIEF DESCRIPTION OF THE DRAWINGS

Having thus described embodiments of the invention in general terms, reference will now be made to the accompanying drawings, where:

FIG. 1A is a diagram illustrating a token system, in accordance with embodiments of the present invention;

FIG. 1B is a diagram illustrating a token system, according to other embodiments of the present invention;

FIG. 2 is a diagram illustrating a token system, in accordance with embodiments of the present invention;

FIG. 3 is a diagram illustrating a token system, in accordance with embodiments of the present invention;

FIG. 4 is a diagram illustrating an environment in which systems according to embodiments of the invention operate;

FIG. 5 is a flowchart illustrating a method for expediting setup of digital wallets using contactless credentials according to embodiments of the invention;

FIG. 6 is a flowchart illustrating a method for expediting setup of digital wallets using contactless credentials according to embodiments of the invention;

FIGS. 7A, 7B and 7C are diagrams illustrating an authentication/function continuum according to embodiments of the invention; and

FIG. 8 is a diagram illustrating a process for enabling authentication shifting based on mobile wallet characteristics, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The embodiments presented herein are directed to systems, methods, apparatuses, and computer program products for expediting setup of a digital wallet using contactless credentials. As presented herein, embodiments of the invention reduce potential exposure during the digital wallet setup process. Embodiments improve confidence that a customer is adding a credential (e.g., representing a card number) to a digital wallet is the customer who owns the credential. During a standard setup of a digital wallet, as part of the flow to add a credential to a digital wallet from within an online banking session or mobile application, there may not be a high confidence level that the customer using the login is the real customer. To mitigate this concern, standard processes ask the customer to perform a step up authentication. In some cases, this step-up authentication may include running of an OTP or CVV widget. Embodiments of the invention enable use of a contactless plastic card by a customer having an NFC-enabled device to setup digital wallets. The user taps his or her NFC enabled mobile device and the system reads the card, including reading the card number, expiration date and cryptogram. The system then verifies the contactless data against internal authorization protocols. The system also validates the card belongs to the user, such as by confirming the user identity of the card matches the user identity of the online banking session or mobile application. By using the mobile application authentication process coupled with a verified EMV transaction, the system ensures the user is a trusted customer, and the institution can thereby allow the credential information to be loaded into the digital wallet with no additional verification needed. Additionally, by reading the card electronically (e.g., by NFC), there is no need for a customer to enter any data into the application, thereby further reducing potential exposure.

In accordance with embodiments of the invention, the term “financial transaction” or “transaction” refers to any transaction involving directly or indirectly the movement of monetary funds through traditional paper transaction processing systems (i.e. paper check processing) or through electronic transaction processing systems. Typical financial transactions include point of sale (POS) transactions, automated teller machine (ATM) transactions, internet transactions, electronic funds transfers (EFT) between accounts, transactions with a financial institution teller, personal checks, etc. When discussing that transactions are evaluated it could mean that the transaction has already occurred, is in the processing of occurring or being processed, or it has yet to be processed by one or more financial institutions. In some embodiments of the invention the transaction may be a customer account event, such as but not limited to the customer changing a password, ordering new checks, adding new accounts, opening new accounts, etc.

In accordance with embodiments of the invention, the term “filtration” or “filter” refers to the means or the process of analyzing aspects of a purchase transaction or a financial transaction to evaluate a potential exposure to loss associated with a transaction due to a number of factors including, but not limited to, a compromised payment vehicle or a compromised POS system.

In accordance with embodiments of the invention “account events” comprise any interactions that an individual, such as a customer or unauthorized user may have with an account of the customer. The account may be a financial account, digital wallet, or a customer profile account, which stores customer information, such as addresses, telephone numbers or the like. The interactions with the accounts may be direct or indirect. Indirect interaction may include an online or mobile banking session, in which the individual may not specifically interact with accounts but performs some other financial institution-related activity. As such, account event data may include, but is not limited to, data related to changing account authorization credentials, such as a user identifier and/or password; ordering/re-ordering financial products, such as checks, debit/credit card; changing payment credentials; linking one account to one or more other accounts; opening and/or closing accounts; addition and/or deletion of account users; changing customer or account-specific personal information, such as mailing address; balance inquiries and the like. In some embodiments the account events may be “non-monetary events” such that monetary events are not related to the account events, however, in some embodiments the account events may include a monetary component.

In accordance with embodiments of the invention, “account activities” refers to historical patterns in the transactions of a consumer over a period of time. For example, the “velocity” or “velocity count” is part of account activities and refers to the number of transactions or cumulative amounts of transactions associated with an account, payment vehicles, or related accounts that occurs within a specified time period; for example, eleven transactions of $50 within a day, seven transactions of $1000 or more within an hour. In other embodiments, “transaction history” is a party of account activities, and refers to the types, amounts, locations, products, or other patterns in the purchasing history of the account.

In accordance with embodiments of the invention, “geo-positioning” or “geo-caching” refers to the physical location associated with a financial transaction or account event. Geo-positioning may utilize information about the location of each transaction or account events related to one or more customer accounts. Geo-positioning may relate to each of the types of information described above (i.e., transaction information, account activities, and account events).

For example, the geo-positioning of a point of sale (POS) transaction may be the physical location of the POS, the geo-positioning of an Internet transaction may be the IP address of the user, and the like. Geo-positioning data includes: a physical address; a post office box address; an IP address; a phone number, a locality (e.g., a state, a county, a city, and/or the like); a country; geographic coordinates; or any other type of data that indicates a geographical location. The geo-positioning data can be associated with a transaction, an account event, a user, a transaction device (e.g., POS, automated teller machine (ATM), physical teller at a bank, consumer mobile device, or the like), a financial institution, a business, the location of the user's mobile device, and the like. The geo-positioning data may include, for example, a place of domicile of a user, a work location of a user, a secondary home (e.g., a vacation home), etc.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

In accordance with embodiments of the invention the terms “customer” and “user” and “consumer” may be interchangeable. These terms may relate to a direct customer of the financial institution or person or entity that has authorization to act on behalf of the direct customer, user, or consumer (i.e., indirect customer).

Various embodiments of the present invention relate to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token (e.g., provide a link or information that directs a system to a location of a token), in order to represent the specific account number during a transaction. In other embodiments of the invention, the digital wallet may store some or all of the user account information (e.g., account number, user name, pin number, or the like), including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments this may be the merchant or another third party that stores the token), and the transaction may be processed accordingly.

Specific tokens, in some embodiments, may be tied to a single user account, but in other embodiments, may be tied to multiple user accounts, as will be described throughout this application. In some embodiments a single tokens could represent multiple accounts, such that when entering into a transaction the user may select the token (or digital wallet associated with the token) and select one of the one or more accounts associated with the token in order to allocate the transaction to a specific account. In still other embodiments, after selection of the token by the user the system may determine the best account associated with the token to use during the transaction (e.g., most cash back, most rewards points, best discount, or the like). In addition, the tokens may be associated with a specific digital wallet or multiple digital wallets as desired by the institutions or users.

Moreover, the tokens themselves, or the user accounts, individual users, digital wallets, or the like associated with the tokens, may have limitations that limit the transactions that the users may enter into using the tokens. The limitations may include, limiting the transactions of the user to a single merchant, a group of multiple merchants, merchant categories, single products, a group a products, product categories, transaction amounts, transaction numbers, geographic locations, or other like limits as is described herein.

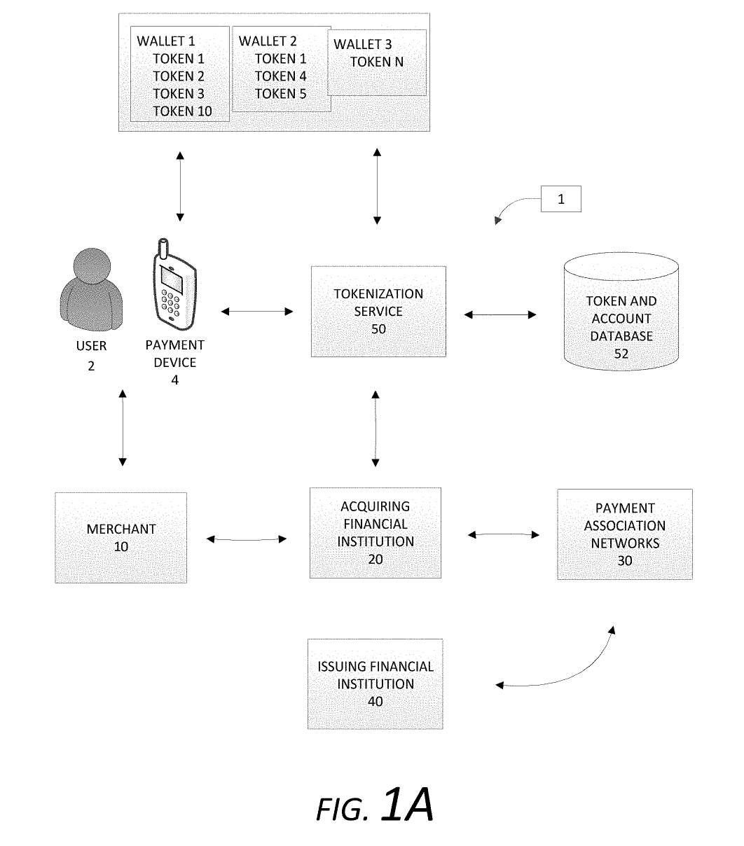

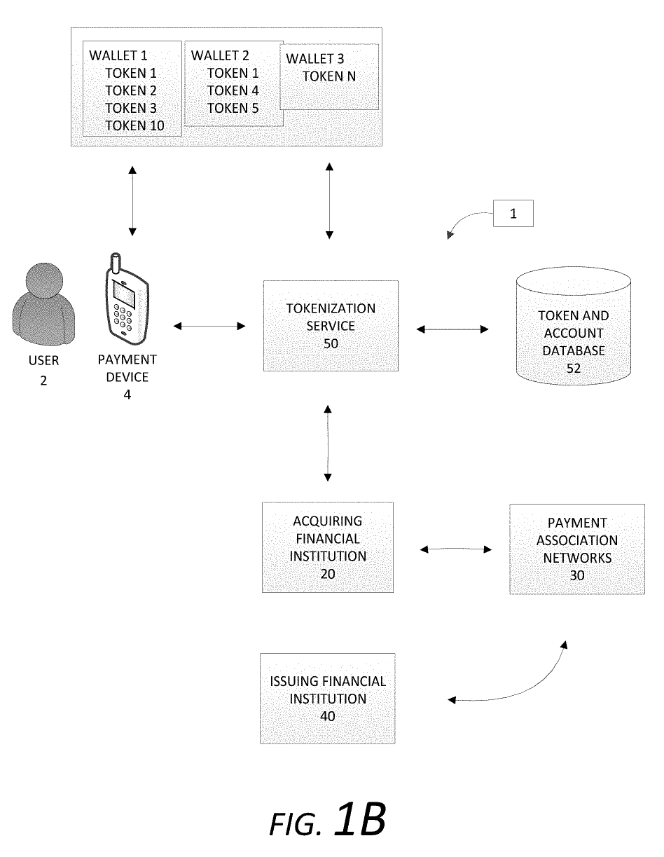

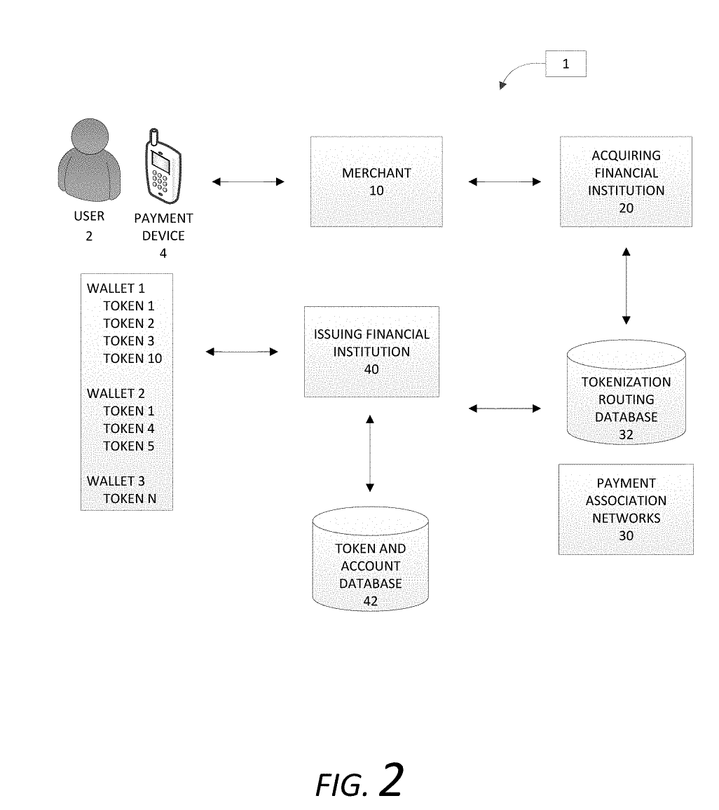

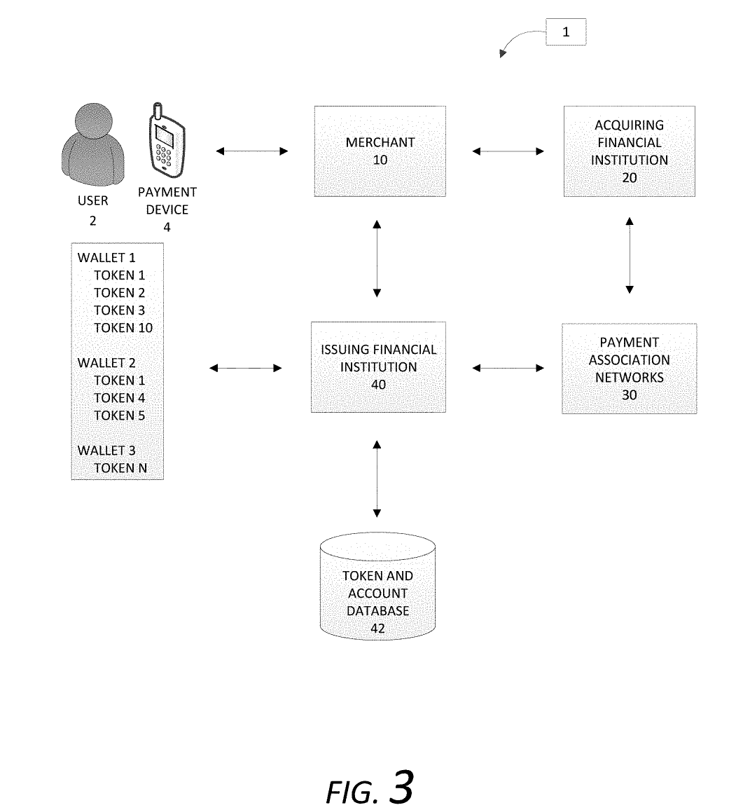

FIG. 1A, FIG. 1B, FIG. 2 and FIG. 3 illustrate a number of different ways that the user 2 may use one or more tokens in order to enter into a transaction, as well as how the parties associated with the transaction may process the transaction. FIG. 1A, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1A (as well as in FIGS. 1B, 2 and 3), a user 2 may utilize a payment device 4 (or in other embodiments a payment instrument over the Internet) to enter into a transaction. FIG. 1A illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like), or other like payment devices 4. As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument (e.g., a payment application that stores the token) may be used to enter into the transaction. The payment instrument may be the same as the token or digital wallet associated with the payment device 4, except they are not associated with specific payment device. For example, the token or digital wallet may be associated with a payment application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1A, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, any other limit described herein, or the like) associated with the token that may limit the transactions in which the user 2 may enter. The limits may be placed on the token by the user 2, or another entity (e.g., client, administrator, person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described occurs when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the tokenization service indicates that the transaction meets the limits), then the acquiring financial institution 20 thereafter sends the user account number, the other user information, and the transaction information directly to the issuing financial institution 40, or otherwise indirectly through the card association networks 30. The issuing financial institution 40 determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token.

Instead of the process described above, in which the acquiring financial institution 20 requests the token from the tokenization service 50, in some embodiments the tokenization service 50 may receive the transaction request and transaction information from the merchant 10 or acquiring financial institution 20. Instead of providing the account number to the acquiring financial institution 20, the tokenization service 50 may send the transaction request and transaction information to the issuing financial institution 40 directly, or indirectly through the payment association networks 30.

The embodiment illustrated in FIG. 1A prevents the user account number and other user information from being presented to the merchant 10; however, the tokenization service 50, acquiring financial institution 20, the card association networks 30, and the issuing financial institution 40 may all utilize the actual user account number and other user information to complete the transaction.

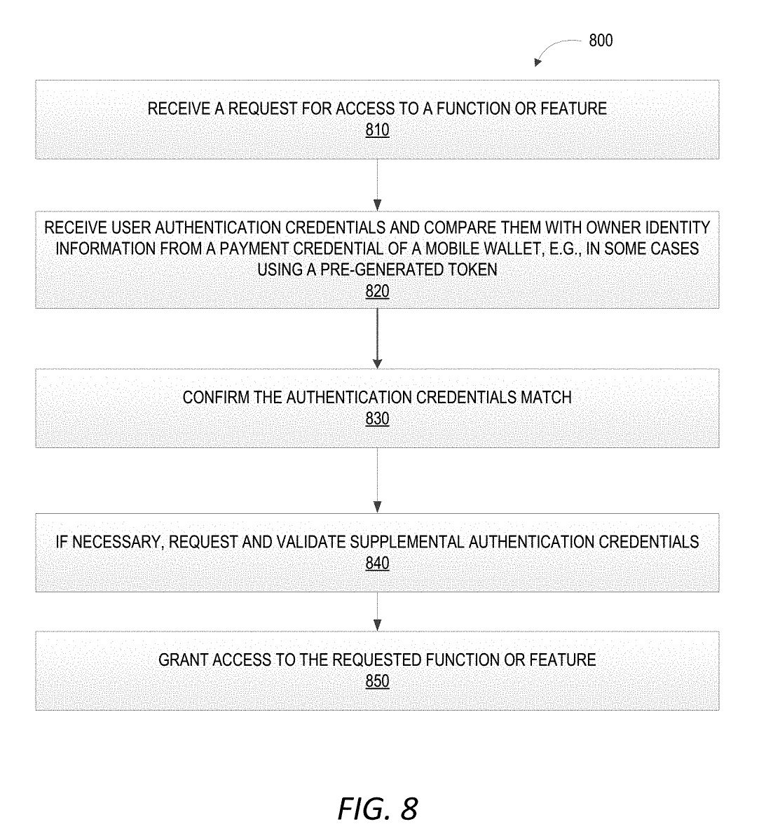

Referring now to FIG. 1B, a token system according to embodiments of the invention is illustrated. In such embodiments of the system the merchant 10 present in FIG. 1A has been removed. This configuration may be applicable in situations related to the digital wallet authentication processes discussed specifically with reference to FIG. 8 below. In such a configuration, a pre-generated token may be stored in the digital wallet at creation (or otherwise) of the wallet and used for authentication purposes. Hence, the token is not provided to a merchant or third party entity in a payment situation, in some embodiments, but rather the token is generated and used exclusively (or in some cases nearly exclusively) for authentication purposes.

FIG. 2 illustrates another embodiment of a token system process 1, in which the user 2 may utilize a payment device 4 (or payment instrument over the Internet) to enter into transactions with merchants 10 utilizing tokens instead of user account numbers. As illustrated in FIG. 2, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 3). In other embodiments, the issuing financial institution 40 may create the digital wallet for the user 2 (e.g., through a wallet created for a business client or retail client associated with the user 2) and include one or more tokens for various types of transactions, products, or the like. The issuing financial institution 40 may store the tokens, the associated user account information (e.g., including the user account number), and any limits on the use of the tokens, as was previously described with respect to the tokenization service 50 in FIG. 1. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with the tokens and the corresponding issuing financial institutions 40 to which transactions associated with the tokens should be routed. However, in some embodiments no customer account information would be stored in this tokenization routing database 32, only the instructions for routing particular tokens may be stored.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token, the user account associated with the token, or other limits described herein. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 2 allows the user and the financial institution to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

FIG. 3 illustrates another embodiment of the token system process 1, in which the user 2 may utilize a payment device 4 (or payment instrument over the Internet) to enter into transactions with a merchant 10 utilizing a token instead of a user account number and/or other user account information. As illustrated in FIG. 3, the user 2 may have one or more tokens associated with the payment device 2, the one or more digital wallets, or one or more user accounts within the digital wallets. The one or more tokens may be stored in the user's payment device 4 (or within the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the payment device 4 itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information to the issuing financial institution 40 directly, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system process 1 in FIG. 2, the token system process 1 in FIG. 3 allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1 through 3 are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant 10, or other institutions in the payment processing system do not have access to the actual user accounts or account information.

As briefly discussed above, if the issuing financial institution 40 creates the digital wallet not only does the issuing financial institution 40 receive transaction information along the normal processing channels, but the financial institution 50 may also receive additional transaction information from the user 2 through the digital wallet using the application program interfaces (APIs) or other applications created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the users 2 enter into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 1 through 3.

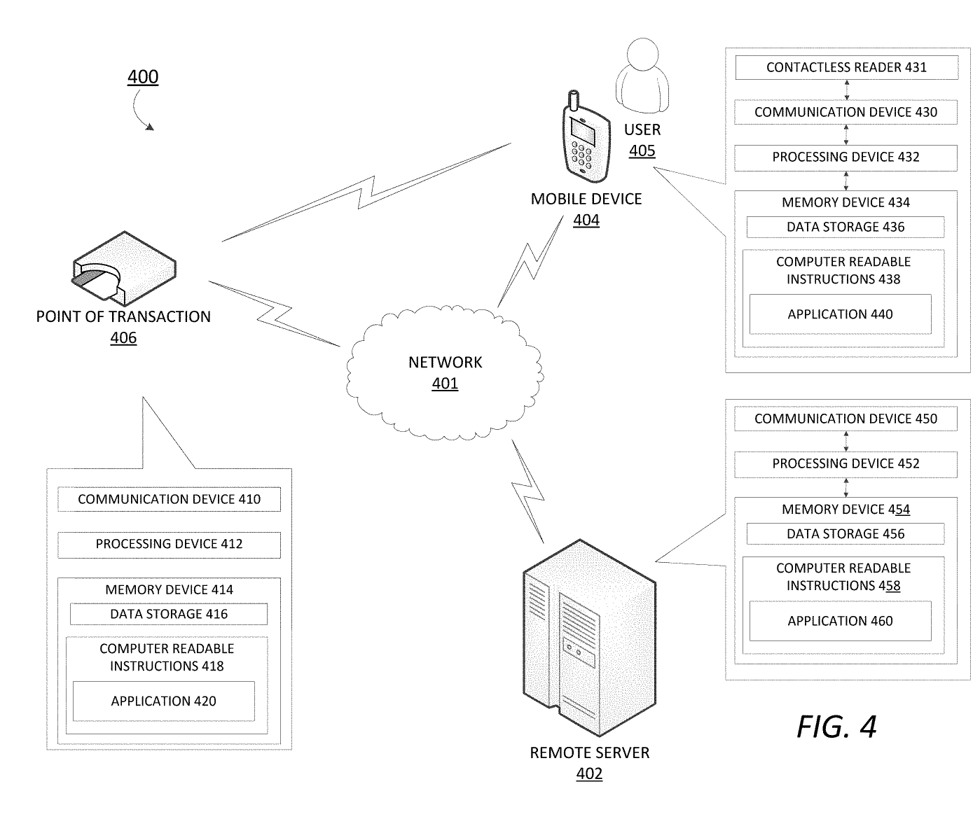

Referring to FIG. 4, a network environment is illustrated in accordance with embodiments of the present invention. As illustrated in FIG. 4, the remote server 402 is operatively coupled via a network 401 to the mobile device 404 and/or a point of transaction (POT) 406. In this configuration, the remote server 402 may send information to and receive information from the mobile device 404 and/or the POT 406. Additionally, the mobile device 404 may send and receive communications directly from the POT 406. The remote server 402 may be or include one or more network base stations or other network components. FIG. 4 illustrates only one example of an embodiment of a network environment 400, and it will be appreciated that in other embodiments one or more of the systems, devices, or servers may be combined into a single system, device, or server, or be made up of multiple systems, devices, or server.

The network 401 may be a global area network (GAN), such as the Internet, a wide area network (WAN), a local area network (LAN), a telecommunication network or any other type of network or combination of networks. The network 401 may provide for wireline, wireless, or a combination wireline and wireless communication between devices on the network 401.

In some embodiments, the user 405 is an individual who maintains cellular products with one or more providers.

As illustrated in FIG. 4, the remote server 402 generally comprises a communication device 450, a processing device 452, and a memory device 454. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device.

The processing device 452 is operatively coupled to the communication device 450 to communicate with the network 401 and other devices on the network 401. As such, the communication device 450 generally comprises a modem, server, or other device for communicating with other devices on the network 401.

As further illustrated in FIG. 4, the network remote server 402 comprises computer readable instructions 458 of an application 460. In some embodiments, the memory device, 454 includes data storage 456 for storing data related to and/or used by the application 460. The application 460 may perform one or more of the steps and/or sub-steps discussed herein and/or one or more steps not discussed herein. For example, in some embodiments, the application 460 may determine an exposure has occurred, determine a digital wallet has an associated payment credential and/or initiate one or more exposure reduction measures.

As illustrated in FIG. 4, the mobile device 404 generally comprises a contactless reader 431, a communication device 430, a processing device 432, and a memory device 434. The processing device 432 is operatively coupled to the communication device 430, the contactless reader 431 and the memory device 434. In some embodiments, the processing device 432 may send or receive data from the mobile device 404, to the remote server 402 via the communication device 430 over a network 401. As such, the communication device 430 generally comprises a modem, server, or other device for communicating with other devices on the network 401. The contactless reader 431 may be or include a NearField Communication (NFC) device reader for communicating or reader an NFC chip located on a payment credential such as a payment card.

As further illustrated in FIG. 4, the mobile device 404 comprises computer readable instructions 438 stored in the memory device 434, which in one embodiments includes the computer-readable instructions 438 of an application 440. In the embodiment illustrated in FIG. 4, the application 440 allows the mobile device 404 to be linked to the remote server 402 to communicate, via a network 401. The application 440 may also allow the mobile device to connect directly (i.e. locally or device to device) with the POT 406 for performing a transaction. The application 440 may perform one or more of the steps and/or sub-steps discussed herein and/or one or more steps not discussed herein. For example, in some embodiments, the application 440 may determine an exposure has occurred, determine a digital wallet has an associated payment credential and/or initiate one or more exposure reduction measures.

As illustrated in FIG. 4, the POT 406 may include a communication device 410, a processing device 412, and a memory device 414. The processing device 412 is operatively coupled to the communication device 410 and the memory device 414. In some embodiments, the processing device 412 may send or receive data from the mobile device 404 and/or the remote server 402 via the communication device 410. Such communication may be performed either over a direct connection and/or over a network 401. As such, the communication device 410 generally comprises a modem, server, or other device for communication with other devices on the network 401.

As further illustrated in FIG. 4, the POT 406, comprises computer-readable instructions 418 of an application 420. In the embodiment illustrated in FIG. 4, the application 420 allows the ATM 406 to be linked to the remote server 402 to communicate, via a network 401. The application 420 may also allow the mobile device 406 to connect directly (i.e., locally or device to device) with the POT 406 or indirectly through the network 401. The application 420 may perform one or more of the steps and/or sub-steps discussed herein and/or one or more steps not discussed herein.

It is understood that the servers, systems, and devices described herein illustrate one embodiment of the invention. It is further understood that one of more of the server, systems, and devices can be combined in other embodiments and still function in the same or similar way as the embodiments described herein.

In various embodiments, the POT device may be or include a merchant machine and/or server and/or may be or include the mobile device of the user may function as a point of transaction device. The embodiments described herein may refer to the use of a transaction, transaction event or point of transaction event to trigger the steps, functions, routines etc. described herein. In various embodiments, occurrence of a transaction triggers the sending of information such as alerts and the like. Unless specifically limited by the context, a “transaction”, “transaction event” or “point of transaction event” refers to any communication between the user and the merchant, e.g. financial institution, or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

As used herein, a “user device” or “mobile device” may be a point-of-transaction device as discussed, or may otherwise be a device carried by a user configured to communicate across a network such as a cellular network, wireless fidelity network or otherwise. As used here a “user” refers to a previous customer or a non-customer of one or more merchants or entities associated with one or more merchants.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an automated teller machine (ATM) or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like).

In some embodiments, information associated with the purchase transaction is received from a POT including a point-of-sale (POS) terminal during a transaction involving a consumer and a merchant. For example, a consumer checking out at a retail merchant, such as a grocer, may provide to the grocer the one or more goods or products that he is purchasing together with a payment method, loyalty card, and possibly personal information, such as the name of the consumer. This information along with information about the merchant may be aggregated or collected at the POS terminal and routed to the system or server of the present invention or otherwise a third party affiliate of an entity managing the system of this invention. In other embodiments when the purchase transaction occurs over the Internet, the information associated with the purchase transaction is collected at a server providing an interface for conducting the Internet transaction. In such an embodiment, the consumer enters product, payment, and possibly personal information, such as a shipping address, into the online interface, which is then collected by the server. The server may then aggregate the transaction information together with merchant information and route the transaction and merchant information to the system of the present invention. It will be further be understood that the information associated with the purchase transaction may be received from any channel such as an automated teller machine (ATM), Internet, peer-to-peer network, POS, and/or the like.

The term “potential exposure to loss,” as used herein, refers to any of, but is not limited to, the possibility of economic loss (e.g., financial loss), the possibility of a loss of data (e.g., personally identifiable information and the like), a possibility of a loss of access, a possibility of a compromised payment vehicle or information associated with a payment vehicle, and/or the like.

As discussed above, embodiments of the invention enable expediting setup of a digital wallet using contactless credentials. As presented herein, embodiments of the invention reduce potential exposure during the digital wallet setup process. Embodiments improve confidence that a customer is adding a credential (e.g., representing a card number) to a digital wallet is the customer who owns the credential. During a standard setup of a digital wallet, as part of the flow to add a credential to a digital wallet from within an online banking session or mobile application, there may not be a high confidence level that the customer using the login is the real customer. To mitigate this concern, standard processes ask the customer to perform a step up authentication. In some cases, this step-up authentication may include running of an OTP or CVV widget.

Embodiments of the invention enable use of a contactless plastic card by a customer having an NFC-enabled device to setup digital wallets. The user taps his or her NFC enabled mobile device and the system reads the card, including reading the card number, expiration date and cryptogram. The system then verifies the contactless data against internal authorization protocols. The system also validates the card belongs to the user, such as by confirming the user identity of the card matches the user identity of the online banking session or mobile application.

By using the mobile application authentication process coupled with a verified EMV transaction, the system ensures the user is a trusted customer, and the institution can thereby allow the credential information to be loaded into the digital wallet with no additional verification needed. Additionally, by reading the card electronically (e.g., by NFC), there is no need for a customer to enter any data into the application, thereby further reducing potential exposure.

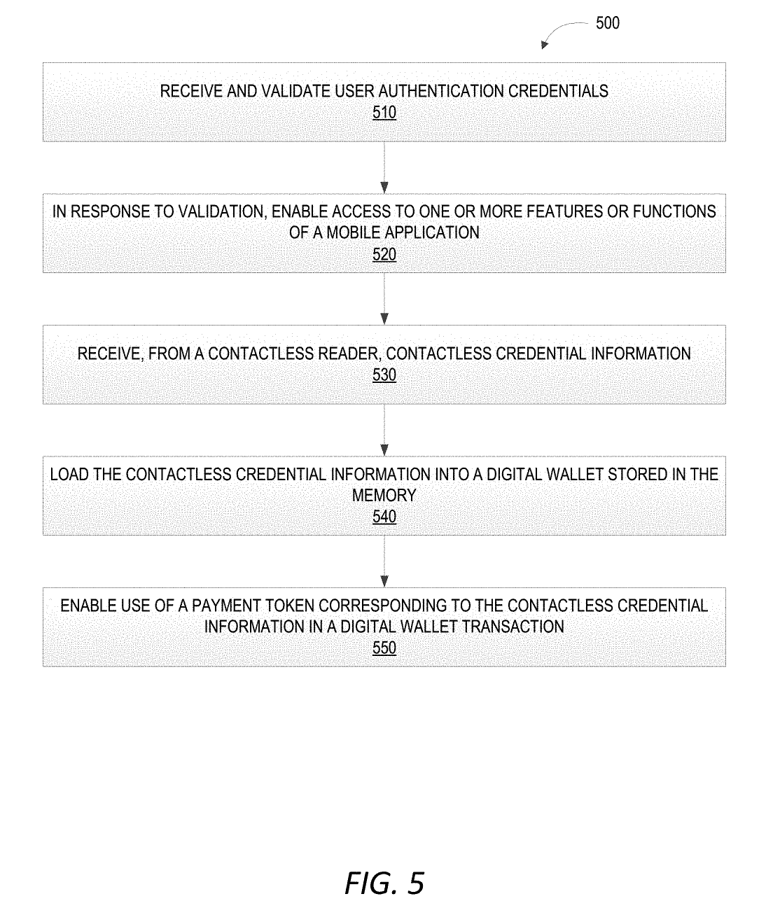

Referring now to FIG. 5, a flowchart illustrates a method for expedited setup of digital wallets using contactless credentials. The first step, as represented by block 510, is to receive and validate user authentication credentials. Such credentials may be provided by the user in an online banking session or mobile application login and may be or include username, password, PIN, biometric credentials such as fingerprint and the like. The next step, represented by block 520, is, in response to validation, to enable access to one or more feature or functions of a mobile application (or online banking session). Next, as represented by block 530, is to receive, from a contactless reader of a mobile device, contactless credential information. The contactless reader may be configured to read and/or communicate wirelessly with a contactless chip or other communication device of a payment credential (such as a payment card enabled with an NFC chip). In other embodiments, the contactless reader may be or include a magnetic reader for reading a magnetic strip of a classic bank card.

Next, as represented by block 540, embodiments load the contactless credential information (or a corresponding token) into a digital wallet stored in the memory of the mobile device. As discussed below, the digital wallet and/or the payment credential or corresponding token may be stored in a separate memory than the instructions for executing the various steps discussed herein for improving memory and processing efficiencies of the mobile device and/or system. Finally, as represented by block 550, embodiments enable use of a payment token corresponding to the contactless credential information in a digital wallet transaction.

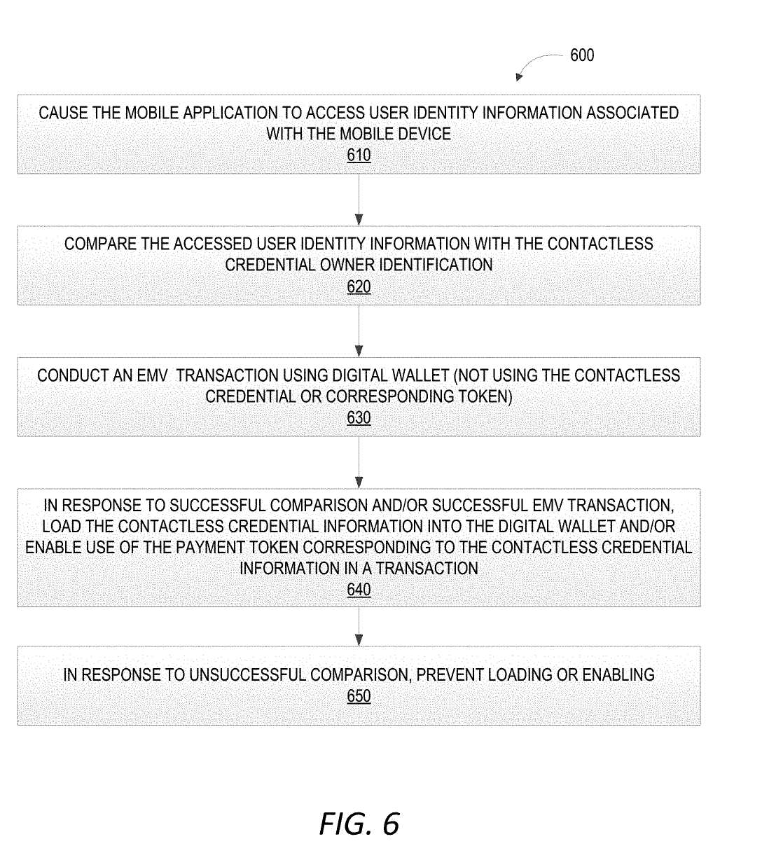

Referring now to FIG. 6, a flowchart illustrates a method for expedited setup of digital wallets using contactless credentials. The first step, as represented by block 610, is to cause the mobile application to access user identity information associated with the mobile device. This information may be accessed locally in the memory of the mobile device or may be requested from a remote system such as an institution system. The next step, as represented by block 620, is to compare the accessed user identity information with the contactless credential owner identification. Then, as represented by block 630, in some embodiments, the mobile device conducts an EMV transaction using the digital wallet (not using the contactless credential or corresponding token). Then, in response to successful comparison and/or successful completion of the EMV transaction using the digital wallet, the mobile device loads the contactless credential information into the digital wallet and/or enables use of the payment token corresponding to the contactless credential information in a transaction. In response to an unsuccessful comparison, embodiments may prevent the loading or enabling referring to in step 640.

In some embodiments, simply the presence of a pre-generated token provides a level of authentication, which in some cases may be sufficient for enabling access to a particular feature or function, and in some cases may be insufficient absent step-up or supplemental authentication by the user. Such a pre-generated token may be placed in the digital wallet of the mobile device or may be separate from the digital wallet and not used for transactions with third parties, but rather, only be used as an authentication token with an authenticating entity.

The different types of authentication may provide differing degrees of confidence regarding the authentication using such types. For example, if a username by itself is used for a first user authentication, and a username along with a password is used for a second authentication, then the second authentication should provide a higher confidence regarding the authentication because of the additional layer of authentication required. Further, within the types of authentication, varying levels of confidence may be used. For example, when using a password, an administrator may require users to create a password according to strict rules designed to increase the security level of the password, and therefore increase the confidence of any authentication using the password.

Accordingly, a continuum of authentication may be used to quantify (or dictate) the levels of authentication. Likewise, a continuum of functions permitted may be used to quantify (or dictate) the number or context in which functions are permitted.

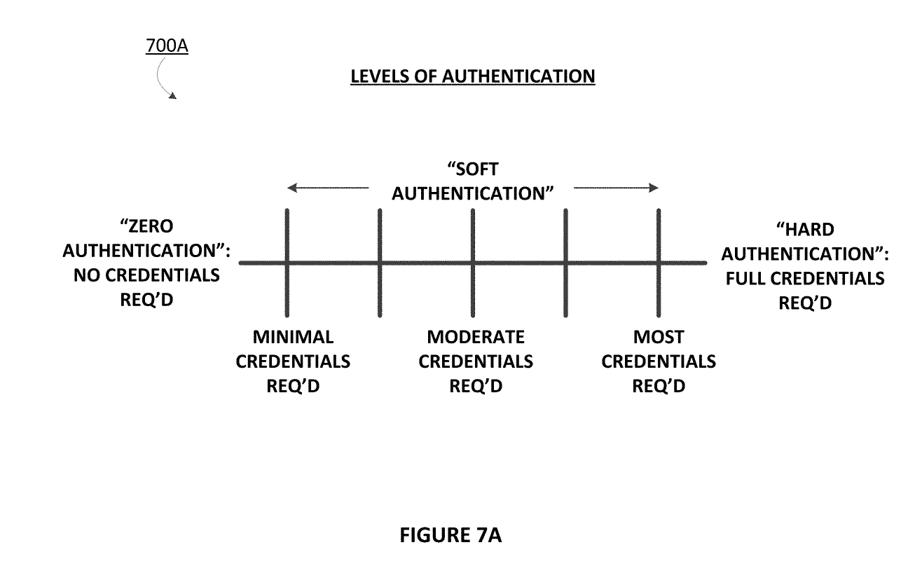

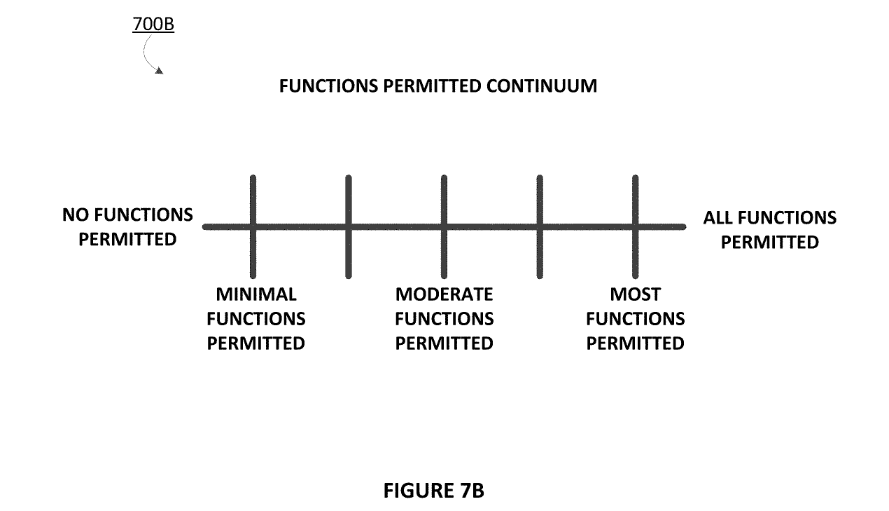

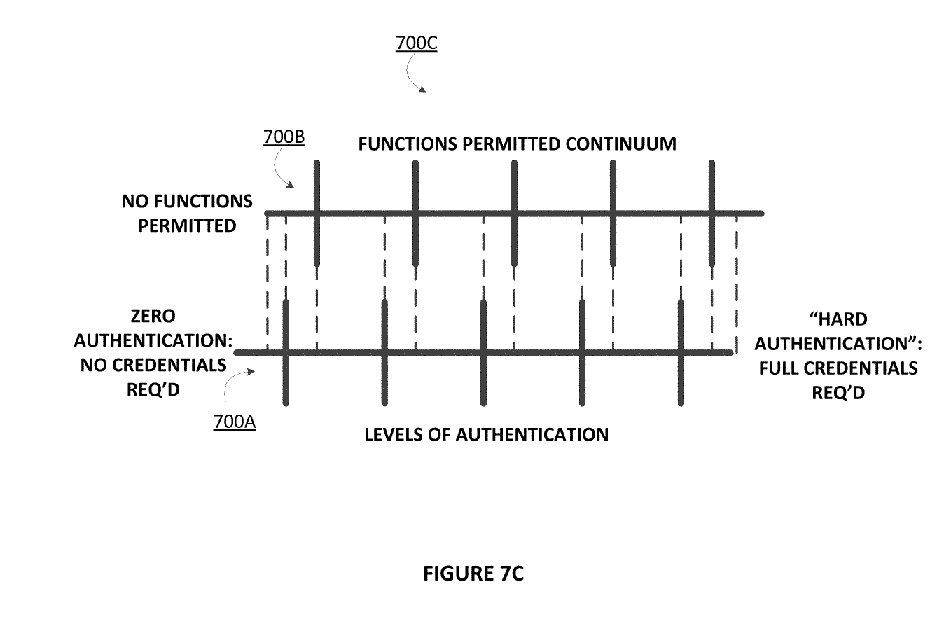

Referring to FIG. 7A, a continuum of authentication 700A is illustrated according to embodiments of the invention. On the left-hand side of the continuum, a “zero authentication” requires no authentication credentials. On the right-hand side of the continuum, a “hard authentication” requires full authentication credentials. This means that it requires the strictest combination of credentials. In between the two extremes, “a soft authentication” requires minimal credentials, moderate credentials or most credentials for various points along the continuum. The continuum generally represents the number of credentials required and/or the relative strength of the credentials required for that point on the continuum. As discussed below with reference to FIG. 7C, the continuum of authentication 700A may be coupled with an application functions permitted continuum 700B, first illustrated in FIG. 7.

Referring to FIG. 7B, the functions permitted continuum 700B illustrates various levels of functions, access, and/or transactions permitted. Functions may refer to what a user is permitted to “see” and/or what the user is permitted to “do”. More specifically, this may refer to whether a specific function is permitted at a certain point on the continuum and/or the context in which a certain function is permitted. The left-hand side of the continuum indicates that no functions are permitted, and the right-hand side of the continuum indicates that all functions are permitted. In between the extremes, minimal functions are permitted, moderate functions are permitted and most functions are permitted. Thus, any given point along the continuum 700B corresponds with a certain amount and/or number of functions that are permitted and/or the context in which certain functions are permitted.

Referring now to FIG. 7C, a diagram 700C illustrates a coupling of the application functions permitted continuum 700B and the levels of authentication continuum 700A. As shown, the continua 700B and 700A may be coupled with one another such that the various points along the continua intersect at specific points of the coupled continuum. For example, one continuum may be moved left or right with respect to the other continuum in order to achieve a different relationship between the functions permitted and the credentials required. Accordingly, for a given coupling, a specific point on continuum 700A provides that a particular function or functions may be permitted given that a specified level of authentication credentials are supplied, as indicated by the corresponding point on continuum 700A. For example, a financial institution and/or a user may arrange the continua 700B and 700A with respect to one another and may adjust the arrangement based on changing desires or goals.

In some embodiments, one or both the continua 700B and 700A may have weighted scales such that, as a point on the continuum is moved, the corresponding functions permitted and/or level of authentication required may change exponentially or otherwise. Furthermore, in various embodiments, other representations of the various functions permitted that correspond with the various levels of authentication may be used by the invention.

According to various embodiments of the invention, a step-up authentication protocol leverages pre-generated digital wallet token(s). Thus, the invention provides authentication “step-up” that effectively reduces the amount and/or number of credentials required for performing particular mobile application and/or online banking features by using a pre-generated digital wallet token. The pre-generated digital wallet token may, in some cases, be generated when a digital wallet is set-up, such as discussed in greater detail above. In this way, the owner's identity may be partially or completely authenticated simply by the presence of a valid token in the user's digital wallet. To perform some type of function within the mobile application, the user may then have to provide some supplementary level of authentication such as a CVV code, PIN or otherwise in order to perfect the authentication.

Referring now to FIG. 8, a method for providing step-up authentication and enabling access to a requested feature or function is illustrated. The first step, as represented by block 810, is to receive a request for access to a function or feature. The next step, as represented by block 820, is to receive user authentication credentials and compare them with owner identity information from a payment credential of a mobile wallet. In some cases, the mobile device may have a pre-generated token stored in a digital wallet that is used for this authentication. The pre-generated token may be generated during a set-up of a digital wallet as discussed above. The presence of the token may provide a particular level of authentication confidence in the user of the mobile device and thus may eliminate or reduce the amount of authentication required for the requested feature or function.

Next, as represented by block 830, is to confirm the authentication credentials match. If necessary, as represented by block 840, is to request and validate supplemental authentication credentials. Finally, once the user is validated based on the mobile wallet payment credential or token presence or information, and if necessary any supplemental authentication credentials, the user is granted access to the requested function or feature, as represented by block 850.

In some embodiments, authentication based on a mobile wallet token or payment credential may be supplemented by requiring that a transaction has been successfully completed using the payment credential or token. For example, in some cases, the authentication process may require that the mobile wallet has used the payment credential in an EMV transaction, and based on successful completion of the EMV transaction with the payment credential or token in the mobile wallet, the mobile device may reduce or eliminate further authentication requirements based on the level of feature or function being requested.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory devices described above may include any computer memory that provides an actual or virtual space to temporarily or permanently store data and/or commands provided to the processing device(s) described above when they carries out its functions described herein.

In some embodiments, digital wallets, tokens, transaction information, and the like may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

In some cases, more than one network, system or communication pathway makes up one or more dedicated communication channels for communication between the mobile device and institution systems discussed herein. In some cases, only those pathways make up the dedicated communication channel(s). In some embodiments, the institution system serves as a control system and sends control signals that cause the mobile device to establish a dedicated communication channel between the mobile device and the institution systems. In some cases, the dedicated communication channel is optimized so that the information may be communicated more efficiently than is could be over a non-dedicated communication channel. For example, a non-dedicated communication channel may utilize insecure network connections or systems or may utilize unstable or noise-prone network connections or systems. Thus, when establishing a dedicated communication channel, the control system may optimize parameters of the dedicated communication channel such that the communication channel is less prone to interruption from security breach, other traffic, offline systems or the like. This may be done by, for example, designating certain systems on the network between the control system and the mobile device, respectively, as low-functioning, medium-functioning, or high-functioning network systems/hubs/connections/channels (collectively referred to as network systems). In various other embodiments, the number of categories of systems may be raised or lowered. For example, there may be five (5) distinct categories of systems. The various network systems may be categorized by one or more administrators and/or automatically based on one or more monitoring modules or applications running on the various systems. Such a monitoring system may flag any abnormalities in network communication such as an unintended offline network system, a security breach of a network system, a network communication affected negatively by noise or interference (in some cases based on a predetermined threshold of interference or communication errors). Thus, once various network systems are categorized, the control system and/or the mobile device may optimize the dedicated communication channel by selecting appropriately categorized network systems for the communication channel. For example, the mobile device may establish a dedicated communication channel in order to send and receive authentication credentials and validation, tokens for validation, or newly issued tokens. When establishing the dedicated communication channel, the mobile device or control system may only select high-functioning network systems in order to ensure that the high priority information may be reliably communicated from the mobile device to the control system and vice versa. In another example, certain mobile devices (and/or their installed mobile applications) are designated or categorized and always provided a dedicated (or non-dedicated) communication channel based on their respective categorization.

It will further be understood that the system having the process flow 500 can be configured to perform any of the portions of the process flows 600 and/or 800 upon or after one or more triggering events (which, in some embodiments, is one or more any of the portions of the process flows 500, 600 and/or 800). As used herein, “triggering event” refers to an event that automatically triggers the execution, performance, and/or implementation of a triggered action, either immediately, nearly immediately, or sometime after (e.g., within minutes, etc.) the occurrence of the triggering event. For example, in some embodiments, the system performing any of the portions of the process flows 500, 600 and/or 800 is configured such that the system receiving an indication of a compromised payment vehicle or a potential exposure to loss (the triggering event) automatically and immediately or nearly immediately triggers the system to automatically (without human intervention) generate a token for facilitating or completing a pending purchase transaction (the triggered action).

Also it will be understood that, in some embodiments, a predetermined time and/or the passage of a predetermined per any of the portions of the process flows 500, 600 and/or 800. Of course, any of the embodiments described and/or contemplated herein can involve one or more triggering events, triggered actions, automatic actions, and/or human actions.

In addition, it will be understood that, in some embodiments, a system performing any of the portions of the process flows 500, 600 and/or 800 (and/or a user thereof) is configured to perform each portion of the process flows 500, 600 and/or 800, from start to finish, within moments, seconds, and/or minutes (e.g., within approximately 10-15 minutes, etc.). In some embodiments, any of the portions of the process flows 500, 600 and/or 800 are performed in real time, in substantially real time, and/or at one or more predetermined times. Further, it will be understood that the number, order, and/or content of any of the portions of the process flows 500, 600 and/or 800 are exemplary and may vary. It will further be understood that the any of the portions of the process flows 500, 600 and/or 800 can be configured to perform any one or more of the portions of any one or more of the embodiments described and/or contemplated herein.

In various embodiments of the invention, transaction limits and/or thresholds may be used. For example, transaction limits may be used to determine whether a payment credential has been exposed. If a transaction (e.g., transaction information) fails to meet a limit, the transaction may be denied. Alternatively, if a transaction (e.g., transaction information) meets a limit, then the transaction may be allowed.

While the system has been described as determining whether the transaction meets the limits and thereby determining whether an exposure has occurred, in some embodiments filters for determining exposure may also be responsive to transaction information. For example, exceptions to filters may allow a transaction even if a filter is not met. In an embodiment, the system evaluates the transaction information to determine: (1) does the transaction meet the limits; and (2) if the transaction does not meet the limits, does the transaction qualify for an exception to the limits. If the system determines that a positive response to either query, then transaction may be allowed.

In some embodiments, the exceptions are based at least in part upon the transaction information. For example, the system may determine that a transaction does not meet a category limit because doing so would cause the token to exceed the category limit for the time period. In this example, however, the system also determines that the token is near, e.g., within one week, within three days, within one day, or the like, the expiration date of the token or the current evaluation period for the token and that the token has remaining funds in a different category. Given the short period of time remaining for the expenses to be made, the system may determine that the transaction falls within an exception and allow the transaction. In another example, the system may determine that the user is outside of geographic limits defined by a route. The system, however, determines that the user has conducted a transaction at the merchant frequently in the past and therefore allows the transaction based on the previous number of transactions at the merchant. These examples use multiple types of transaction information, e.g., the date of the transaction, the location of the transaction, the category of the transaction, the amount of the transaction, and the like, to determine if the exceptions apply. In some embodiments, only a single piece of transaction information applies. For example, the system may always permit transactions that are associated with a specific category, for example, emergency expenses. The system may always permit transactions at emergency rooms, doctors' offices, and the like.

In some embodiments, the exceptions are determined by the system and/or the user. For example, the system may provide a list of exceptions based on the user's transaction history. If the user has a favorite coffee shop, the system may allow transactions at the coffee shop up to a certain amount even if the transaction would not meet a limit. The user or an administrator may provide exceptions based on location or other transaction information. For example, the user may input exceptions that allow transactions within a specific region, e.g., a city, that would not be allowed outside of the specific region. The exceptions may be changed at any time by the system or user.

The exceptions may be limited by frequency, amount, percentage of the limit, or the like. For example, a transaction may qualify for an exception but only up to a certain percentage of the funds remaining in a related category. For example, a transaction may qualify for an exception because the expense period for the token is almost expired and there are remaining funds in a first category. The system may permit a transaction in a second category up to some percentage (e.g., 50%) of the funds remaining in the first category.

The transaction-responsive limits are designed to provide flexibility to the system and better serve the user. The transaction-responsive limits may be tailored to the user or generic to the token and/or system. By providing for transaction-responsive limits, the system allows transactions that would otherwise be denied based on binary yes/no limits when the transaction information indicates the appropriateness of the transaction.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 7562US1.014033.2941 | To be | EXPEDITED | Concurrently |
| | assigned | SETUP | Herewith |
| | | OF DIGITAL | |
| | | WALLET USING | |
| | | CONTACTLESS | |
| | | CREDENTIAL | |
| 7563US1.014033.2942 | To be | ESTABLISHING | Concurrently |
| | assigned | DEDICATED | Herewith |
| | | CONNECTION | |
| | | FOR TOKEN | |
| | | REPLACEMENT | |

What is claimed is:

1. A mobile device for providing step-up authentication, the mobile device comprising:
a memory;
a processor; and
a module stored in the memory, executable by the processor, and configured to:
receive a request for access to a function or feature by a user of the mobile device;
receive first user authentication credentials from the user;
access a mobile wallet storing at least one payment credential associated with an owner of the mobile device, the at least one payment credential comprising owner identity information;
compare the first user authentication credentials with the owner identity information;
confirm the first user authentication credentials match the owner identity information; and
enable access to the requested function or feature.

2. The mobile device of claim 1, wherein the module is further configured to:
determine that additional user authentication is required for access to the requested function or feature;
receive second user authentication credentials;
validate the second user authentication credentials; and
in response to validation, enable access to one or more features or functions of a mobile application.

3. The mobile device of claim 1, further comprising:
a contactless reader;
wherein the module is executable by the processor and further configured to:
receive, from the contactless reader, contactless credential information comprising owner identification, credential number, expiration date and cryptogram;
load the contactless credential information into a digital wallet stored in the memory; and
enable use of a payment token corresponding to the contactless credential information in a digital wallet transaction.

4. The mobile device of claim 3, wherein the module is further configured to:
cause the mobile application to access user identity information associated with the mobile device;
compare the accessed user identity information with the contactless credential owner identification; and
in response to successful comparison, load the contactless credential information into the digital wallet and enable use of a payment token corresponding to the contactless credential information.

5. The mobile device of claim 3, wherein the module is further configured to:
conduct an EMV transaction using the digital wallet and the payment credential;
based on successful completion of the EMV transaction using the digital wallet and the payment credential and successful authentication validation, enable access to the requested function or feature.

6. The mobile device of claim 3, wherein the contactless reader comprises an NFC reader and the contactless credential comprises a contactless payment card including an NFC chip.

7. The mobile device of claim 1, wherein the module is further configured to:
generate a digital wallet token representing a hard payment credential in conjunction with a digital wallet set-up process; and
wherein the stored payment credential is the digital wallet token.

8. A method for providing step-up authentication, the method comprising:
receive a request for access to a function or feature by a user of the mobile device;
receiving first user authentication credentials from the user;
accessing a mobile wallet storing at least one payment credential associated with an owner of the mobile device, the at least one payment credential comprising owner identity information;
comparing the first user authentication credentials with the owner identity information;
confirming the first user authentication credentials match the owner identity information; and
enabling access to the requested function or feature.

9. The method of claim 8, further comprising:
determining that additional user authentication is required for access to the requested function or feature;
receiving second user authentication credentials;
validating the second user authentication credentials; and
in response to validation, enabling access to one or more features or functions of a mobile application.

10. The method of claim 8, further comprising:
receiving, from a contactless reader, contactless credential information comprising owner identification, credential number, expiration date and cryptogram;
loading the contactless credential information into a digital wallet stored in the memory; and
enabling use of a payment token corresponding to the contactless credential information in a digital wallet transaction.

11. The method of claim 10, further comprising:
causing the mobile application to access user identity information associated with the mobile device;
comparing the accessed user identity information with the contactless credential owner identification; and
in response to successful comparison, loading the contactless credential information into the digital wallet and enable use of a payment token corresponding to the contactless credential information.

12. The method of claim 10, further comprising:
conducting an EMV transaction using the digital wallet and the payment credential;
based on successful completion of the EMV transaction using the digital wallet and the payment credential and successful authentication validation, enabling access to the requested function or feature.

13. The method of claim 10, wherein the contactless reader comprises an NFC reader and the contactless credential comprises a contactless payment card including an NFC chip.

14. The method of claim 8, further comprising:
generating a digital wallet token representing a hard payment credential in conjunction with a digital wallet set-up process; and
wherein the stored payment credential is the digital wallet token.

15. A computer program product for providing step-up authentication, the computer program product comprising a non-transitory computer-readable medium comprising code causing a mobile device to:
receive a request for access to a function or feature by a user of the mobile device;
receive first user authentication credentials from the user;
access a mobile wallet storing at least one payment credential associated with an owner of the mobile device, the at least one payment credential comprising owner identity information;
compare the first user authentication credentials with the owner identity information;
confirm the first user authentication credentials match the owner identity information; and
enable access to the requested function or feature.

16. The computer program product of claim 15, wherein the code further causes the mobile device to:
determine that additional user authentication is required for access to the requested function or feature;
receive second user authentication credentials;
validate the second user authentication credentials; and
in response to validation, enable access to one or more features or functions of a mobile application.

17. The computer program product of claim 15, wherein the code further causes the mobile device to:
receive, from a contactless reader, contactless credential information comprising owner identification, credential number, expiration date and cryptogram;
load the contactless credential information into a digital wallet stored in the memory; and
enable use of a payment token corresponding to the contactless credential information in a digital wallet transaction.

18. The computer program product of claim 15, wherein the code further causes the mobile device to:
cause the mobile application to access user identity information associated with the mobile device;
compare the accessed user identity information with the contactless credential owner identification; and
in response to successful comparison, load the contactless credential information into the digital wallet and enable use of a payment token corresponding to the contactless credential information.

19. The computer program product of claim 15, wherein the code further causes the mobile device to:
conduct an EMV transaction using the digital wallet and the payment credential;
based on successful completion of the EMV transaction using the digital wallet and the payment credential and successful authentication validation, enable access to the requested function or feature.

20. The computer program product of claim 15, wherein the code further causes the mobile device to:
generate a digital wallet token representing a hard payment credential in conjunction with a digital wallet set-up process; and
wherein the stored payment credential is the digital wallet token.
